(19) United States
(12) Patent Application Publication
(10) Pub. No.: US 2011/0007747 A1
(43) Pub. Date: Jan. 13, 2011

(54) Internet Protocol Trace Back Using Dynamic Reconfigurable Logic Hardware

(75) Inventor: Jonathan W. Ellis, Austin, TX (US)

Correspondence Address: LEE & HAYES, PLLC, 601 W. RIVERSIDE AVENUE, SUITE 1400, SPOKANE, WA, 99201, US

(73) Assignee: Advanced Communication Concepts, Inc., Austin, TX (US)

(21) Appl. No.: 12/500,822

(22) Filed: Jul. 10, 2009

(51) Int. Cl. H04L 12/56

(52) U.S. Cl. 370/401

(57) ABSTRACT

Implementations of a dynamic reconfigurable hardware in an IP Trace Back system are described.

### BACKGROUND

Current Internet based infrastructures may be extremely vulnerable to motivated and well equipped attackers. For example, an attack may be conducted with data packets or packets received by widely deployed routers of a particular infrastructure. The packets may be used to disable the routers, by corrupting hash algorithms used in the routers. In particular, the hash algorithms may be used in a Bloom filter, where the Bloom filter creates data summaries of the data packets received by the routers. To account for these attacks, sources of the packets (i.e., sent by the attackers) are identified.

In an implementation, identifying the sources of the packets is to have each router in a network record every packet that the router receives and forwards. The Bloom filter may be used in the router to reduce the amount of information that is stored. The router may be queried to determine whether the packets were forwarded, and determining the route of the packets to be traced back to their destination. Such a scheme may allow malicious packets to be traced back along uncorrupted routers, in order to find their source (i.e., attackers).

A problem may arise when the hash algorithms in the Bloom filter are known to the attacker, which may allow the attacker to corrupt the routers. The attacker may corrupt the hash algorithms, which in turn may compromise execution of the functions of the Bloom filter. Exemplary functions of the Bloom filter may include tracing back the sources of the data packets; providing means to speed up or simplify packet routing protocols; and creating the data summaries in the routers. The Bloom filter, as known in the art, may include different implementations; however, the different implementations (e.g., compressed Bloom filter, Spectral Bloom filters, etc.) may include a common problem in security, where the hash algorithms may be detected and used by the attackers as discussed above.

When attackers possess the knowledge of the hash values (i.e., hash algorithms) used in the Bloom filter, the attackers may spoof their Internet Protocol (IP) addresses, and send data packets to attack the Internet infrastructure at any given time. Such attacks may make it difficult in tracing back the sources of the data packets. Thus, the ability of the attackers to gain knowledge of the hash values (i.e., patterns in hash algorithms) should be eliminated.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a block diagram of a network topology in an Internet Protocol Trace Back system.

FIG. 2 is a block diagram of a router using a Bloom filter with reconfigurable logic hardware.

FIG. 3 is an exemplary implementation of a replaceable and reconfigurable logic chip.

FIG. 4 is a flow chart to avoid detection of hash algorithms in a Bloom filter.

### DETAILED DESCRIPTION

This disclosure is directed towards techniques and methods of implementing a dynamic reconfigurable hardware to avoid detection of hash algorithms in a Bloom filter. In an Internet Protocol (IP) Trace Back system, the Bloom filter may be used to trace back an identity or sources of data packets; provide means to speed up or simplify packet routing protocols; and create data summaries in routers or other network devices. A problem may arise when false positives in the Bloom filter are caused by data packets or packets sent by a potential attacker to corrupt the Bloom filter (e.g., cracked hash algorithms). To provide security for the Bloom filter, dynamic reconfigurable hardware selects and implements hash algorithms. The hash algorithms may be randomly changed periodically in order to avoid detection by attackers. In an implementation, a reconfigurable logic chip may be used to provide changes in the hash algorithms. The reconfigurable logic chip may be configured to be replaceable (i.e., reprogrammable), and include different libraries of hash algorithms. To this end, the hash algorithms are moving targets that may avoid detection by potential attackers.

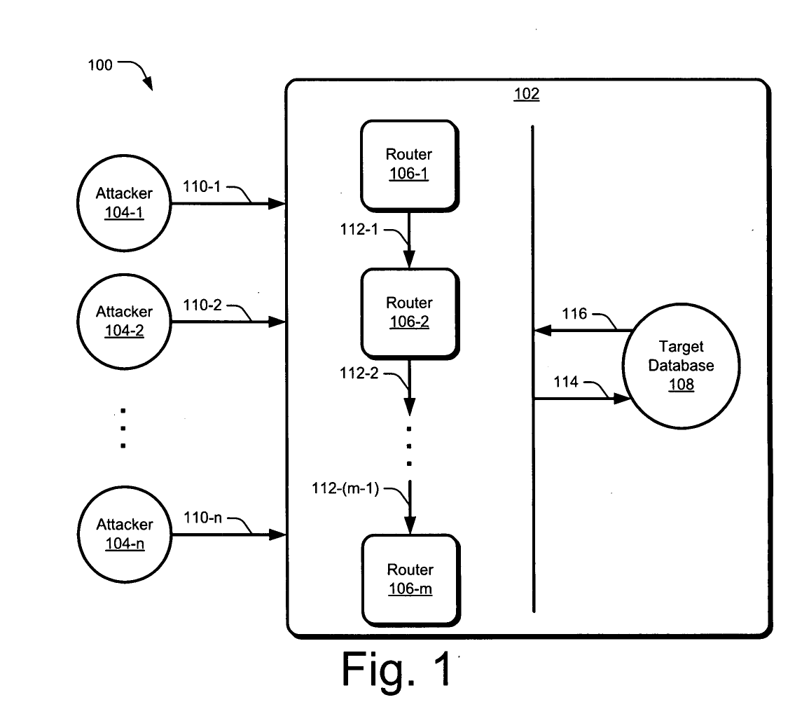

FIG. 1 illustrates a diagram of a network topology 100 for an Internet Protocol (IP) Trace Back system 102. The network topology 100 include users, and potential attackers 104-1, 104-2, . . . 104-n, where “n” is an integer, and hereinafter referred to as attackers 104. The network topology 100 include routers 106-1, 106-2, . . . 106-m, where “m” is an integer, and hereinafter referred to as routers 106. The network topology 100 include target database 108. The network topology 100 may include a global network of interconnected computers that enable users, which include attackers 104, to share information along multiple channels (i.e., routers 106). In particular, the network topology 100 is implemented through the Internet.

In an implementation, the IP Trace Back system 102 uses a Bloom filter in the routers 106 and the target database 108. The Bloom filter is a simple space efficient randomized data structure for representing a set (e.g., data packets or packets) in order to support membership queries (e.g., whether the packets are received by the routers 106). The Bloom filter may allow false positives but space savings often outweigh this drawback when a probability of an error (i.e., in the false positives) is within acceptable level. The false positives may indicate that a certain element belongs to a set, even though the element is not included in the set. For example, a set A includes S_{A} elements, and a set B also includes S_{B} elements. If it is desired that the S_{B} elements not contained in the S_{A} elements, are transferred to the set A, then the set A may send a Bloom filter to the set B. The set B checks each S_{B} elements against the Bloom filter sent by the set A, and transfers the S_{B} elements that are not in the S_{A} elements according to the Bloom filter. To this end, all the S_{B} elements that are not in the S_{A} elements, are transferred to the set A; however, the false positives may include a small probability that the S_{B} elements are actually contained in the S_{A} elements.

In the IP Trace Back system 102, the Bloom filter uses hash algorithms to store data packets received by the routers 106. The hash algorithms may provide a functional representation of the packets, in order to speed up query during tracing back of the data packets sources. The data packets may be sent by attackers 104, and include individual IP addresses identifying their sources. An exemplary IP address may include a 32 bit (4 byte) binary number that uniquely identifies the source of the data packets. Attackers 104 may spoof (i.e., misrepresent) the IP address to hide the sources of the packets sent.

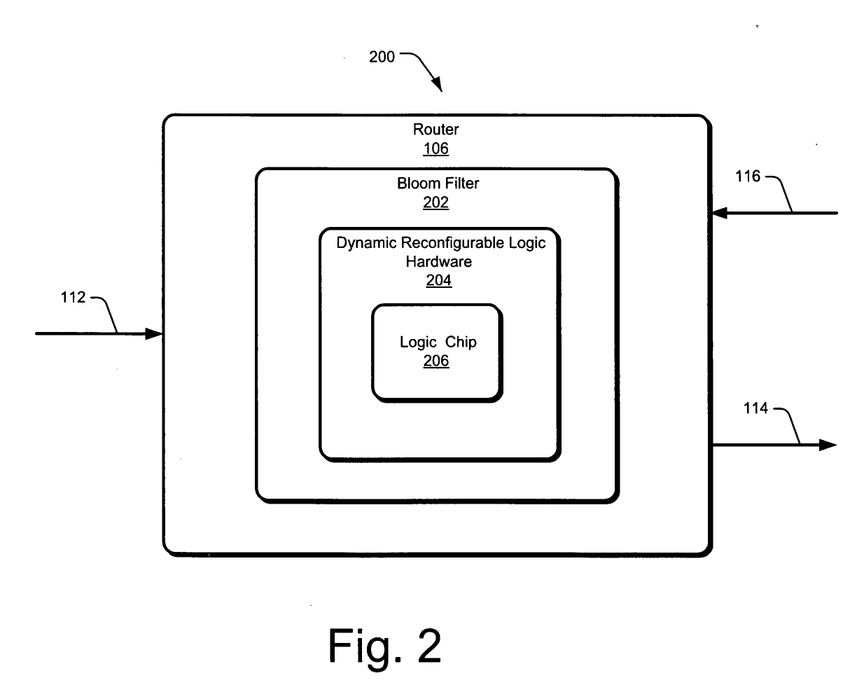

In order for the attackers 104 to send a set of packets to corrupt a certain index, or hash values, in a Bloom filter (used in routers 106), the attackers 104 may first collect a pattern of data used in the Bloom filter. The pattern of data may include hash algorithms used in the Bloom filter. The collecting of the data may allow attackers 104 to detect the hash algorithms used in the Bloom filter, since there is no mathematical solution to solve (i.e., determine) the exact hash values or hash algorithms used. For example, attackers 104 with vast resources (e.g., a rouge nation state) may be inclined to collect the data first, study the pattern, and use the data pattern later to corrupt the Bloom filter. In an implementation, the Bloom filter uses protocol hopping in order to avoid detection of the hash algorithms as discussed below in FIG. 2.

Each of the routers 106 may include a Bloom filter that uses the hash algorithms to perform multiple functions in the network topology 100. Exemplary functions may include creating data summaries in the routers 106; providing means to speed up packet routing protocols; and tracing back an identity or sources of data packets.

The creating of the data summaries may include storing the set of data packets that are received and forwarded by the routers 106. The Bloom filter uses the hash algorithms to store the set of data packets that are received and forwarded by the routers 106. The ability of the Bloom filter to create the data summaries may simplify the packet routing protocols, and provides a speedy and efficient query during tracing back the identity or sources of the packets.

The Bloom filter may provide means to speed up packet routing protocols by routing a query to where packets are stored. When the routers 106 receive the query, hash algorithms in the Bloom filter may be used to direct the query to an index where the desired packets are found. False positives in the Bloom filter may cause the query routing to go down an incorrect path. To this end, the false positives are maintained to an acceptable level for speedy and efficient query.

The Bloom filter may be used to trace back the identity of the attackers 104 that spoof their respective IP addresses. The attackers 104 may insert a false sender IP address into an Internet transmission in order to gain unauthorized access to a computer system. The IP spoofing may be used by the attackers 104 during the transfer of the data packets to attack a particular target database 108. When the hash algorithms are known to the attackers 104, identification of the spoofed IP addresses through the Bloom filter may be difficult to implement. In other words, the attackers 104 may be able to figure out the hash algorithms used by the Bloom filter, and use the hash algorithms to their advantage. To this end, the hash algorithms used in the Bloom filter are dynamically reconfigured to avoid detection as further discussed below.

The target database 108 may include institutional databases, such as commercial and military databases, that use the functions of the Bloom filter. In an implementation, a potential attacker 104-1 may send corrupted hash algorithms (i.e., data packets) through path 110-1 (i.e., selected from paths 110-1, 110-2, . . . 110-n) and received by one or more of routers 106. In particular, router 106-1 receives the corrupted hash algorithms, and the corrupted hash algorithms are passed through paths 112-1, 112-2, . . . 112-(m-1), and received by router 106-m. The corrupted hash algorithms are eventually received at target database 108 through a path 114. In other cases, the paths may use different router combinations (e.g., router 106-2 connects to router 106-6, router 106-6 connects to router 106-1, etc.), before the corrupted hash algorithms (i.e., data packets) are received at the target database 108.

During a query through path 116 by the target database 108, if the data packets were received by the routers 106, false positives in the router 104-m (i.e., in the given example) may mistakenly identify that the data packets as having been seen (i.e., received and forwarded by the router 104-m). When attempting to trace back through a reverse path of the data packets sent by the attackers 104, the false positives may be corrupted to an unacceptable value (i.e., high probability of error) such that the functions of the Bloom filter may be compromised. In other words, the Bloom filter may include errors in the creation of the data summaries, such that the tracing back of the spoofed IP addresses are difficult to obtain.

To avoid the corruption of the hash algorithms, which result to errors in the false positives, the Bloom filter may be configured to create and implement multiple independent hash values (i.e., hash algorithms). The multiple independent hash values may prevent discovery of the hash algorithms by the attackers 104. The multiple independent hash values or hash algorithms may be implemented through the use of dynamic reconfigurable logic hardware, in parallel with a software program to speed up processing in the Bloom filter.

FIG. 2 is a block diagram 200 of a router using a Bloom filter with reconfigurable logic hardware. A router 106 may be used for transferring packets for purposes of communications between users, which include attackers 104. The router 106 receives and forwards the packets. The router 106 may include a Bloom filter 202, which uses different hash algorithms in storing the data packets to router database. The different hash algorithms in the Bloom filter 202 are implemented in order to avoid detection by potential attackers (e.g., attackers 104). To avoid detection of the hash algorithms used, the Bloom filter 202 may include dynamic reconfigurable logic hardware 204.

The dynamic reconfigurable logic hardware 204, in parallel with a software program, may be used to create data summaries in the router 106. The creation of the data summaries in the router 106 may use different hash algorithms, which are randomly selected and implemented by the dynamic reconfigurable logic hardware 204 for the Bloom filter 202. In an implementation, the software program is used for a speedy query of data packets that are received by the router 106. The speedy and efficient query on the data summaries in the router 106 may be used to identify and locate the packet sources (i.e., IP addresses). The dynamic reconfigurable logic hardware 204 may be configured through the software program, to speed up execution of functions in the Bloom filter 202.

The dynamic reconfigurable logic hardware 204 may be configured to randomly select a logic chip in a replaceable (i.e., reprogrammable) and reconfigurable logic chip 206. In an implementation, the replaceable and reconfigurable logic chip 206 includes multiple of logic chips. The multiple logic chips may include one or more hash algorithm libraries, to provide high speed processing in the Bloom filter 202. The hash algorithm libraries may be activated dynamically, or when the hash algorithm libraries are technically available as configured in the dynamic reconfigurable logic hardware 204. The dynamic reconfigurable logic hardware 204, by randomly selecting and implementing the one or more hash algorithms in the Bloom filter 202, produces protocol hopping. The protocol hopping may provide security (e.g., data encryption) to the Bloom filter—in the performance of its function in the IP Trace Back system—by providing random hash algorithm patterns which are difficult to collect, and detect by the attacker. Moreover, the protocol hopping creates an acceptable value (i.e., probability) for the false positives in the Bloom filter (e.g., less than 0.001%).

When the false positives in the Bloom filter are within an acceptable value, the sources of packets (e.g., sent by the attacker) may be speedily and efficiently determined. The router 106 (i.e., with uncorrupted hash algorithms) may provide the IP addresses of the data packets received and forwarded during a query.

In other cases, the logic chip 206 and the dynamic reconfigurable logic hardware 204 may be implemented outside the Bloom filter 202. The functions of the logic chip 206, and the dynamic reconfigurable logic hardware 204, remains the same. In other words, the dynamic reconfigurable logic hardware 204 randomly selects different hash algorithms from the logic 206, and implements the different hash algorithms in the Bloom filter 202.

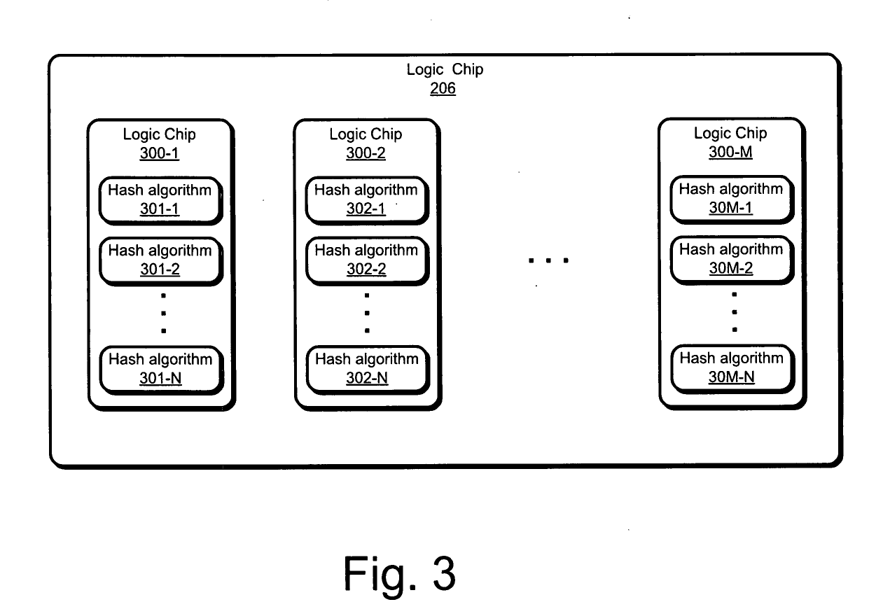

FIG. 3 is an exemplary implementation of the replaceable and reconfigurable logic chip 206. The replaceable and reconfigurable logic chip 206 may include a first logic chip 300-1, a second logic chip 300-2, up to logic chip 206-M, where “M” is an integer. The first logic chip 300-1 may include a set of hash algorithms library that includes hash algorithms 301-1, 301-2, . . . 301-N, where “N” is an integer. The second logic chip 300-2 may also include another set of hash algorithms library that includes hash algorithms 302-1, 302-2, . . . 300-N. The same is true with the third logic chip, and so on, up to logic chip 300-M that includes hash algorithms 30M-1, 30M-2, . . . 30M-N.

A combination of hash algorithms in the logic chips 300-1, 300-2, . . . 300-M, may be selected and implemented in a Bloom filter for a certain period. In other words, the Bloom filter may be configured to implement one or more hash algorithms at the same time, and for a specific duration or period. After this specific period (e.g., after one hour), the Bloom filter may use another one or more hash algorithms from the different hash algorithm libraries, in the different logic chips 300-1, 300-2, . . . 300-M.

For example, five hash algorithms (i.e., hash algorithms 301-1 to 301-5) are selected from the logic chip 300-1, and used at the same time in the Bloom filter for one hour. In the second hour, another seven hash algorithms (i.e., hash algorithms 301-6 to 301-12) from the same logic chip 300-1, are selected and implemented in a Bloom filter. After a certain period, a different chip (e.g., logic chip 300-2) may replace the logic chip 300-1, and implement the dynamic changes in the hash algorithms. To this end, potential attackers (e.g., attackers 104) may not be able to collect the data used in the network topology 100, and corrupt the hash algorithms used in the Bloom filter.

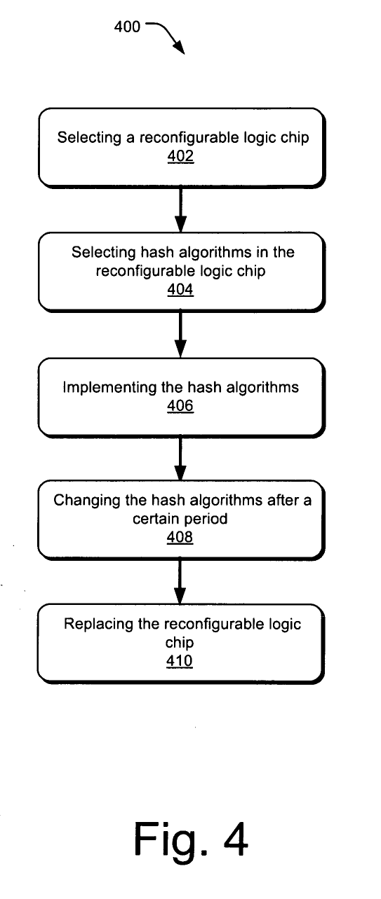

FIG. 4 illustrates an exemplary method 400 for the IP Trace Back system using dynamic reconfigurable logic hardware. In one implementation, the exemplary method 400 can be implemented in the IP Trace Back system 100. The exemplary method 400 is described with reference to FIGS. 1-3. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 402, selecting a chip is performed. In an implementation, reconfigurable logic hardware (e.g., dynamic reconfigurable logic hardware 204) may select a logic chip from a replaceable and reconfigurable logic chip component (e.g., logic chip component 206).

At block 404, selecting hash algorithms is performed. For example, seven hash algorithms (e.g., hash algorithms 301-1 to 301-7) are selected from a reconfigurable logic chip (e.g., logic chip 300-1) by the dynamic reconfigurable logic hardware (e.g., dynamic reconfigurable logic hardware 204).

At block 406, implementing the hash algorithms is performed. In an implementation, the seven hash algorithms (i.e., hash algorithms 301-1 to 301-7) are selected (i.e., from the logic chip 300-1) and implemented in the Bloom filter by the dynamic reconfigurable logic hardware component (e.g., dynamic reconfigurable logic hardware 204).

At block 408, changing hash algorithms is performed. For example, the selected seven hash algorithms (i.e., hash algorithms 301-1 to 301-7) are implemented for one hour, and replaced thereafter. The seven hash algorithms may be replaced with another five hash algorithms (e.g., hash algorithms 301-8 to 301-12) from the same reconfigurable logic chip (e.g., logic chip 300-1), and implemented in the Bloom filter.

At block 410, replacing chip is performed. For example, the reconfigurable logic chip (e.g., logic chip 300-1) is configured to be replaced by another reconfigurable logic chip (e.g., logic chip 300-2), which includes another set of hash algorithm library. The dynamic reconfigurable logic hardware (e.g., dynamic reconfigurable logic hardware 204), in parallel with a software program, initiates and implements the changing of logic chips.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A hardware router that receives and forwards data packets comprising:
a Bloom filter storing the data packets which include an identifiable Internet Protocol (IP) address source;
a logic chip that provides a hash algorithm for the Bloom filter to identify the IP address source of the data packets; and
a dynamic reconfigurable hardware component that selects and implements the hash algorithm for the Bloom filter.

2. The hardware router of claim 1, wherein the Bloom filter uses multiple hash algorithms to produce protocol hopping.

3. The hardware router of claim 2, wherein the multiple hash algorithms are configured to change at random.

4. The hardware router of claim 2, wherein the multiple hash algorithms are selected from different hash algorithm libraries.

5. The hardware router of claim 2, wherein the multiple hash algorithms are selected from different logic chips.

6. The hardware router of claim 2, wherein the protocol hopping provides random hash algorithm patterns.

7. The hardware router of claim 1, wherein the logic chip is reconfigurable.

8. The hardware router of claim 1, wherein the dynamic reconfigurable hardware component selects the hash algorithm from different reconfigurable logic chips.

9. A logic chip comprising:
a hash algorithm library used for a Bloom filter to provide security in hash algorithms used, by protocol hopping; and
a set of reconfigurable logic chips that provides the hash algorithm library used for the Bloom filter.

10. The logic chip of claim 9, wherein the protocol hopping is implemented by using one or more hash algorithms at the same time.

11. The logic chip of claim 9, wherein the protocol hopping is implemented by using one or more hash algorithms over a random period.

12. The logic chip of claim 9, wherein the set of reconfigurable logic chips is implemented in parallel with a software program used during a query of data packets stored in the Bloom filter.

13. The logic chip of claim 9, wherein the set of reconfigurable logic chips provides high speed processing in the Bloom filter.

14. The logic chip of claim 9, wherein the set of reconfigurable logic chips are configured to be replaceable.

15. A method of avoiding detection of hash algorithms in an Internet Protocol trace back system comprising:
selecting a logic chip that provides the hash algorithms;
selecting the hash algorithms in the logic chip to be implemented for a Bloom filter;
implementing the hash algorithms for the Bloom filter; and
changing the hash algorithms implemented for the Bloom filter.

16. The method of claim 15, wherein the selecting of the logic chip is randomly configured.

17. The method of claim 15, wherein the selecting of the logic chip is made from different sets of reconfigurable logic chips.

18. The method of claim 15, wherein the selecting the hash algorithms produces protocol hopping.

19. The method of claim 18, wherein the protocol hopping provides an acceptable value for false positives in the Bloom filter.

20. The method of claim 15, wherein the changing of the hash algorithms is configured to be made constantly after a time period.
